(19) United States
(12) Patent Application Publication
(10) Pub. No.: US 2010/0075628 A1
(43) Pub. Date: Mar. 25, 2010

(54) METHOD AND APPARATUS FOR TRANSMITTING AUTHENTICATED EMERGENCY MESSAGES

(75) Inventor: Baoqing Ye, Acton, MA (US)

Correspondence Address: VERIZON;PATENT MANAGEMENT GROUP, 1320 North Court House Road, 9th Floor, ARLINGTON, VA, 22201-2909, US

(73) Assignee: VERIZON DATA SERVICES LLC, Temple Terrace, FL (US)

(21) Appl. No.: 12/233,753

(22) Filed: Sep. 19, 2008

(51) Int. Cl. H04M 11/04

(52) U.S. Cl. 455/404.2

(57) ABSTRACT

An approach is provided for transmitting an emergency text-based message. A text-based message is received from a mobile device. A determination is made whether the text-based message is an emergency communication from an authorized sender. Location information of the mobile device is accepted if the text-based message is determined to be an emergency communication from an authorized sender.

### BACKGROUND INFORMATION

Modem telecommunications services, particularly wireless mobile communication devices, are essential public safety tools. During emergencies, these devices are indispensable for contacting the appropriate people or authorities. Traditionally, a person would use a mobile device to call for help when an emergency arises. However, there are certain circumstances when the mobile device user may not be able to make a voice call (e.g., when the user cannot speak because of injuries, or when the user must hide his or her call for help from an assailant who is still at the scene). Under these circumstances, the person may be forced to use non-voice communications (e.g., text messaging, instant messaging, or electronic mail) because of the inherently “silent” nature of these types of communications. These types of non-voice communications, however, present a unique set of problems for use during emergencies.

First, there have been no industry standards for sending and receiving emergency messages, making consistency and interoperability between various communications networks a potential problem. Secondly, it is often difficult to create text-based communications under duress because of the extensive typing that may be necessary. It also is difficult to track the location from where the emergency message was sent so that help can be dispatched to that location. Furthermore, it is often difficult to determine the authenticity of emergency non-voice messages because the recipient is not in direct contact with the sender. Finally, the emergency message may not be noticed if the recipient routinely receives large volumes of other messages.

Therefore, there is a need for an approach that enables a user to easily and discretely send an emergency message that alerts the recipient of the sender's emergency and location.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIGS. 1A and 1B, are, respectively, a diagram of a system capable of providing emergency text-based messaging, and a flowchart of processes for supporting such messaging, according to an exemplary embodiment;

FIG. 2 is a diagram of the components of the emergency messaging module, according to an exemplary embodiment;

FIG. 3 is a diagram of a mobile device including an emergency messaging application, according to an exemplary embodiment;

FIG. 4 is a flowchart of a process for configuring an emergency messaging application on a sending device, according to an exemplary embodiment;

FIG. 5 is a flowchart of a process for configuring an emergency messaging application on a receiving device, according to an exemplary embodiment;

FIG. 6 is a flowchart of a process for sending an emergency message, according to an exemplary embodiment;

FIG. 7 is a flowchart of a process for receiving an emergency message, according to an exemplary embodiment; and

FIGS. 8A-8C are diagrams of exemplary controls and user interface screens of a mobile device utilized in the processes of FIGS. 4-7, according to an exemplary embodiment.

FIG. 9 is a diagram of a computer system that can be used to implement various exemplary embodiments.

### DESCRIPTION OF THE PREFERRED EMBODIMENT

A preferred method and apparatus for transmitting authenticated emergency messages are described. In the following description, for the purposes of explanation, numerous specific details are set forth in order to provide a thorough understanding of the preferred embodiments of the invention. It is apparent, however, that the preferred embodiments may be practiced without these specific details or with an equivalent arrangement. In other instances, well-known structures and devices are shown in block diagram form in order to avoid unnecessarily obscuring the preferred embodiments of the invention.

Although various exemplary embodiments are described with respect to a mobile device, it is contemplated that these embodiments have applicability to any device capable of communicating over a network, such as a home communication terminal (HCT), a digital home communication terminal (DHCT), television system set-top box (STB), landline connected to a Public Switched Telephone Network (PSTN), a personal digital assistant (PDA), laptop computer, and/or a personal computer (PC), as well as other like technologies and customer premises equipment (CPE).

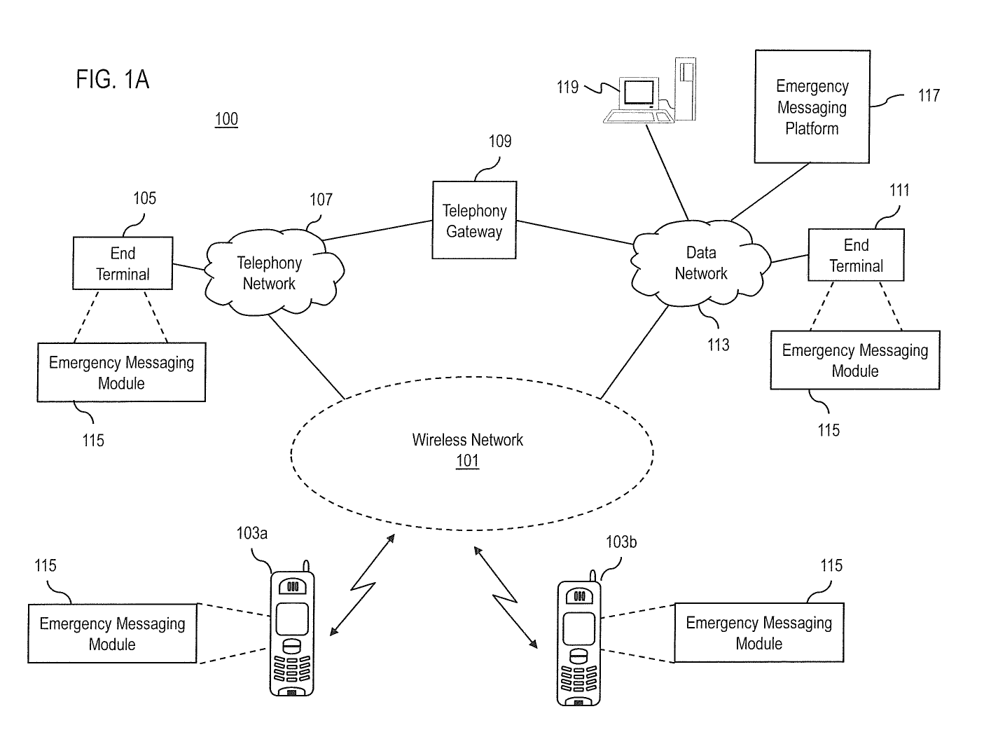

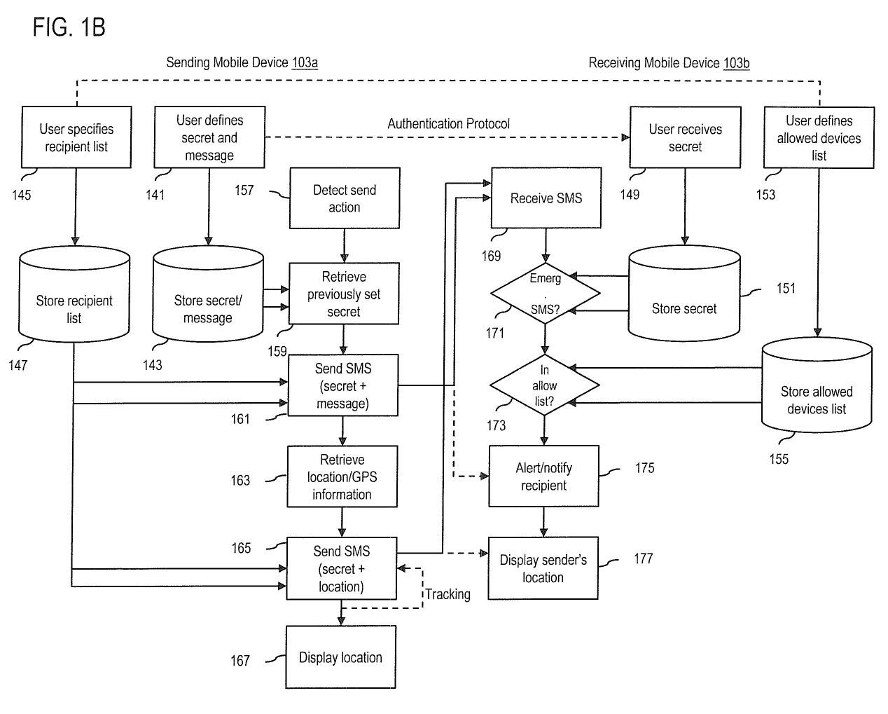

FIGS. 1A and 1B, are, respectively, a diagram of a system capable of providing emergency text-based messaging, and a flowchart of processes for supporting such messaging, according to an exemplary embodiment. For the purposes of illustration, a mechanism for transmitting authenticated emergency messages is described with respect to a communication system 100 that includes a wireless network 101 supporting mobile devices 103a and 103b. The system 100 also supports transmission of authenticated emergency messages to and from an end terminal 105 connected to a telephony network 107 via telephony gateway 109, and an end terminal 111 connected via a data network 113. In this embodiment, the end terminal 105 can be any telephony device capable of communicating over the telephony network 107, and end terminal 111 can be any computing device (e.g., desktop computer, laptop computer, or PDA) capable of communicating over the data network 113.

In addition, the wireless network 101 is a wireless access and transport network, such as a cellular (2 G, 3 G, 4 G, or above), 802.11, 802.15, 802.16, or satellite network; and may employ various mobile communication technologies including, for example, in cellular networks, global system for mobile communications/universal mobile telecommunication system (GSM/UMTS) technologies (i.e., 3GPP technologies) and code division multiple access (cdmaOne/CDMA2000) technologies (i.e., 3GPP2 technologies). The telephony network 107 can be a Public Switched Telephone Network (PSTN), a Public Land Mobile Network (PLMN), or similar. Moreover, the data network 113 can be any local area network (LAN), metropolitan area network (MAN), wide area network (WAN), the Internet, or any other suitable packet-switched network, such as a commercially owned, proprietary packet-switched network, e.g., a proprietary cable or fiber-optic network.

Within the system 100, mobile devices 103a and 103b and end terminals 105 and 111 each contain an emergency messaging module 115 to facilitate sending and receiving emergency messages between devices. The emergency messaging module 115 enables the transmission of authenticated location-based emergency messages between communication devices over existing communications networks. As discussed above, there are certain emergency situations where a user cannot make a voice call for assistance and must rely on non-voice communications such short message service (SMS), multimedia messaging service (MMS), instant messaging (IM), and electronic mail. In this manner, the emergency messaging feature can be an end-to-end service, in which protocols are executed at the end devices by the respective emergency messaging modules 115.

As mentioned, currently no industry standards have been established to govern the transmission of emergency text-based messages. This lack of standards has hindered the implementation of network-based emergency messaging services. As a result, service providers have not been able to deploy these services in a way that can ensure the authenticity and reliability of emergency messages transmitted on the providers' networks. In addition, service providers have not been able to offer tools specifically directed at helping users to send authenticated emergency messages and location-based information.

To address this problem, the emergency messaging module 115 enables a user to pre-configure emergency messages and distribution lists, authenticate outgoing and incoming emergency messages, initiate sending an emergency message using a pre-configured key or key sequence, and track the location of the sender of the emergency message. The user also can configure the module 115 to filter incoming emergency messages based on the sender's identity to guard against unsolicited or unwanted messages and potentially malicious network-based attacks (e.g., denial of service attacks). In addition, it is contemplated that emergency messaging module 115 can be configured to comply with future industry emergency messaging protocols or standards as they become available.

The following example illustrates the capabilities of the emergency messaging module 115. A user is involved in a single-car late-night accident. The accident trapped the user inside the car, and the user has suffered injuries to prevent the user from speaking. The user's mobile device (e.g., cellular telephone) is equipped with the emergency messaging module 115, which has been configured to send an emergency help message and the user's location to another user's mobile telephone when the key “*E” is depressed on the keypad. The user initiates sending the preconfigured help message by entering “*E” on the mobile telephone. A text message is generated and contains a preconfigured authentication protocol, a help message, and location information obtained by the telephone's locator (e.g, global positioning satellite (GPS) receiver or other location-based technologies) to the other mobile telephone. Upon receiving the emergency message, the message is authenticated using the authentication protocol; and an emergency alert and the user's location are presented.

Moreover, the message can be transmitted to more than one recipient concurrently—e.g., family members. This increases the probability that the user's distress message will be noticed and acted upon.

In another scenario, a group of family members attend a large event (e.g., concert) in which one of the members is lost. Although this situation is an “emergency” for the family, it does not rise to the level of an emergency that would warrant notifying the authorities. Also, if the concert is loud or does not permit a voice call, then the lost member can simply invoke this emergency text messaging feature. This feature is particularly useful if the lost member is a small child.

As seen in FIG. 1A, the emergency messaging module 115 resides within each communication device. This configuration enables the emergency messaging module 115 to function without intervention from the service provider network and/or operator, making the application “network-agnostic” (i.e., all core functions of the emergency messaging module 115 are implemented within each communication device instead of on the network). This configuration also enables the emergency messaging module 115 to be deployable directly to each communication device without requiring special network support to operate.

However, it is contemplated that network resources can be used to support the functioning of the emergency messaging module 115 when these resources are available. That is, the emergency messaging service can be implemented as a network service, whereby emergency messaging platform 117 can be utilized to perform authentication of the text messages. This arrangement can thus negate the need to have the module 115 resident on the end-user devices.

The data network 113 permits a host 119 to access functions and settings of the emergency messaging platform 117 via a graphical user interface (GUI) such as a browser application or any web-based application for mobile devices 103a and 103b and end terminals 105 and 111. As a result, the user of the emergency messaging service can input and update settings and configurations for the user's particular device through a web browser or through the communication device itself (e.g., mobile devices 103a and 103b and end terminals 105 and 111).

By way of example, the operation of the emergency messaging module 115 is further detailed in FIG. 1B with respect to short message service (SMS). In this example, mobile device 103a is the emergency message sending device and mobile device 103b is the receiving device. The user can invoke the emergency messaging module 115 in each device by configuring an authentication protocol to ensure the validity of emergency messages. On the sending mobile device 103a, the user can configure an authentication protocol by defining a “secret” (e.g., a secret word, phrase, or code), creating an emergency message (steps 141 and 143), and specifying a recipient list (steps 145 and 147). The emergency messaging module 115 within sending mobile device 103a will then transmit the user-defined secret to the receiving mobile device 103b (steps 149 and 151). As part of the configuration process, the user of the receiving mobile device 103b also can specify an “allowed devices list” (i.e., a list of devices from which the user will accept incoming emergency messages) per steps 153 and 155.

Once configuration is complete, the emergency messaging module 115 of the sending mobile device 103a will monitor for and detect an emergency message send action from the user, per step 157. On a send action (i.e., activity triggering the transmission of the emergency message), the emergency messaging module 115 retrieves the previously configured secret and message, as in step 159, and sends an SMS message containing the secret and message to the receiving mobile device 103b (step 161). If configured by the user, the emergency messaging module 115 also can retrieve the sender's location from the device's GPS hardware (step 163), send an SMS message containing the secret and location information to the receiving mobile device 103b (step 165), and display the sender's cun-ent location on the sending mobile device 103a (step 167). Optionally, if set in tracking mode, the emergency messaging module 115 will periodically send SMS messages with updated location information to the receiving mobile device 103b.

From the perspective of the receiving mobile device 103b, the device 103b detects the receipt of an SMS message, as in step 169. The emergency messaging module 115 in the receiving mobile device 103b then determines whether the SMS message is an emergency message by parsing the text message for the pre-shared secret (step 171). If the message contains the authentication secret, the emergency messaging module 115 checks whether the sender is in the receiving mobile device's allowed devices list, as in step 173. If the sender is in the allow list, the emergency messaging module 115 alerts the recipient (step 175) and displays the incoming emergency SMS along with any accompanying location information (step 177).

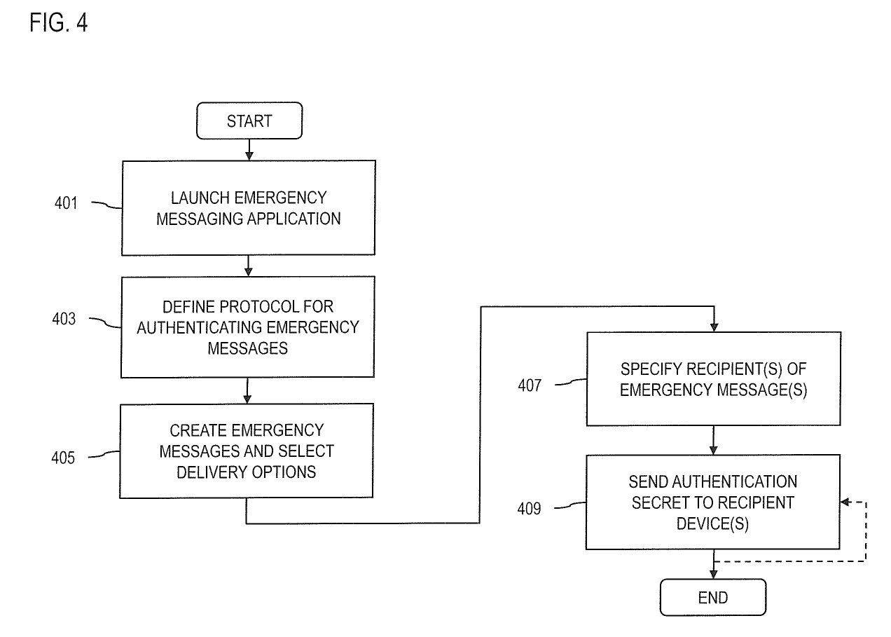

The above processes are further detailed in FIGS. 4-7.

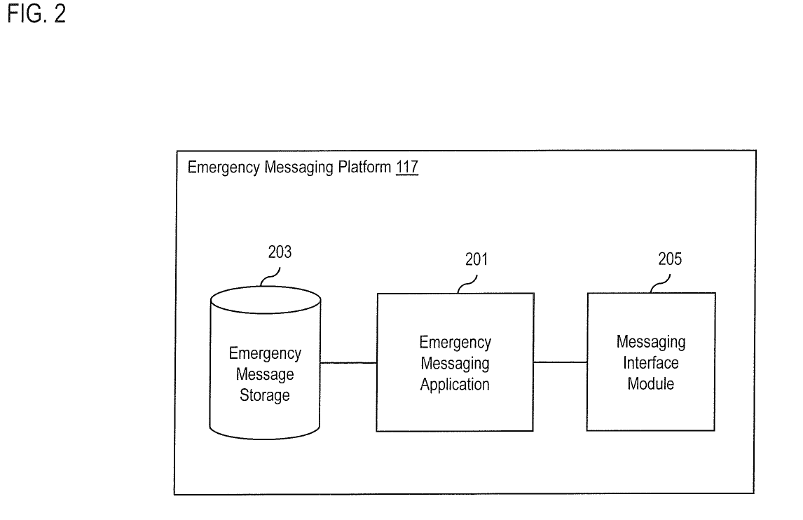

FIG. 2 is a diagram of the components of the emergency messaging platform, according to an exemplary embodiment. In this example, the emergency messaging platform 117 includes the following components: an emergency messaging application 201, an emergency message storage database 203, and a messaging interface module 205. Emergency messaging application 201 is responsible for configuring, transporting, and authenticating emergency messages. In turn, the emergency messaging application 201 has access to a database 203 of user settings and preconfigured emergency messages. The messaging interface module 205 then links the emergency messaging application 201 to the mobile device's communications systems to transmit and receive emergency messages.

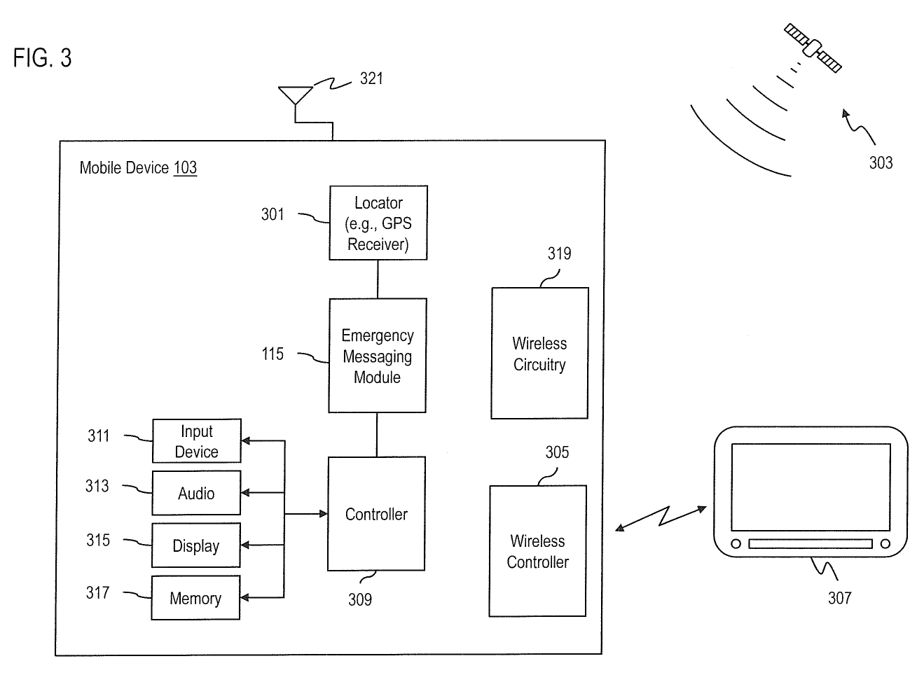

FIG. 3 is a diagram of a mobile device including an emergency messaging module, according to an exemplary embodiment. In this embodiment, the mobile device 103 includes a locator 301 to determine the location of the mobile device 103. By way of example, the locator 301 includes a GPS receiver that receives position data from multiple GPS satellites 303. These GPS satellites 303 transmit very low power interference and jamming resistant signals. At any point on Earth, the locator 301 can receive signals from multiple satellites. Specifically, locator 301 may determine three-dimensional geolocation (or spatial positioning information) from signals obtained from, for instance, at least four satellites. Measurements from satellite tracking and monitoring stations located around the world are incorporated into orbital models for each satellite to compute precise orbital or clock data. GPS signals are transmitted over two spread spectrum microwave carrier signals that are shared by GPS satellites 303. Mobile device 103 needs to identify the signals from at least four satellites 303, decode the ephemeris and clock data, determine the pseudo range for each satellite 303, and compute the position of the receiving antenna. With GPS technology, mobile device 103 can determine its spatial position with great accuracy and convenience. It is contemplated that the various exemplary embodiments are also applicable to other equivalent navigational and location determination technologies. The position data is utilized by the emergency messaging module 115 to provide location infomation that is automatically inserted into emergency messages at the user's option.

In addition (or alternatively), the mobile device 103 can be equipped with a wireless controller 305 to communicate with an external locator 307 (e.g, GPS device or a device utilizing other location-based technology) for acquisition of position data. The external GPS device can employ any number of standard wireless technologies to communicate with the wireless controller 305; for example, the external GPS device can use short range radio transmission technology, such as BLUETOOTH™. It is contemplated that other equivalent short range radio technology and protocols can be utilized. It also is contemplated that the external GPS device may be a compatible stand-alone device, automobile navigation system, or other equivalent system.

A controller 309 is provided to control functions of an input device 311 (e.g., keyboard, touch screen, or other input mechanism), an audio function circuitry 313, a display unit 315, and a memory 317. A user can enter emergency messaging information using the input device 311. The audio function circuitry 313 provides audio cues to the user to support various applications and mobile device functions. Similarly, the display unit 315 provides a display to the user in support of various applications and mobile device functions. The memory 317 can store preconfigured emergency messages, distribution lists, allowed incoming devices lists, and preferences, and other variables for use by the emergency messaging module 115. In addition, the mobile device 103 employs wireless circuitry 319 to communicate over the wireless network 101 (of FIG. 1).

The controller 309 routes the digital signal into the DSP for processing therein, such as speech encoding, channel encoding, encrypting, and interleaving. The encoded signals are then routed to an equalizer for compensation of any frequency-dependent impairments that occur during transmission though the air such as phase and amplitude distortion. The signals may be forwarded from there to a remote telephone which may be another cellular telephone, other mobile phone or a landline connected to a Public Switched Telephone Network (PSTN), or other telephony network 107 (of FIG. 1).

The operation of the emergency messaging module 115 is now described with respect to FIGS. 4-7 and FIGS. 8A-8C.

FIG. 4 is a flowchart of a process for configuring an emergency messaging module on a sending device, according to an exemplary embodiment. In step 401, a user accesses the emergency messaging module 115 on the mobile device 103 from which the user intends to send emergency messages. On the first use, or in configuration mode after the initial use, of emergency messaging module 115, the user will be presented with a set of configuration options for a sending device. To begin configuration, the user first defines an authentication protocol (e.g., use a pre-shared secret), per step 403. The emergency messaging module 115 uses the authentication protocol to authenticate emergency messages sent between the sending and receiving devices (e.g., mobile devices 103a and 103b). This approach is described with respect to an authentication protocol based on the use of a pre-shared authentication secret (e.g., a pre-shared word, phrase, or code), but it is contemplated that other authentication protocols (e.g., biometric authentication or device identification numbers) may be used.

Next, the user creates one or more emergency messages and selects delivery options for each message per step 405. The emergency messaging module 115 will store these pre-created messages for quick access by the user when needed. In certain embodiments, the emergency messaging module 115 may provide default generic messages from which the user can choose. For each message, the user specifies the content of the message (e.g., “In danger, send help immediately,” “Car breakdown,” “I'm lost,” etc.), the type of communication to use (e.g., SMS, MMS, IM, electronic mail), whether to include location information, and whether to send location updates periodically. The user also can specify what key or key sequence will initiate the transmission of each emergency message. For example, the user can specify that holding the “5” key for more than five seconds will initiate sending a particular emergency message. It is contemplated that the user can specify any key or combination of keys pressed for any duration of time to initiate an emergency message. Additionally, the key may be a physical key, a soft key, menu item, or similar.

Finally, the user must specify the recipient or recipients of the message (step 407). Each message can have a different set of recipients and the user can create multiple distribution lists. After the pre-set parameters (secret, recipient list) are configured, in sending mode, the emergency messaging module 115 will send the user-created authentication secret to each emergency message recipient specified by the user (step 409). Step 409 may be repeated. In this way, each potential recipient of the user's emergency messages will have the proper authentication secret to validate incoming emergency messages. The capability to create and store multiple emergency messages enables the user to quickly use the emergency message most appropriate to a given emergency situation.

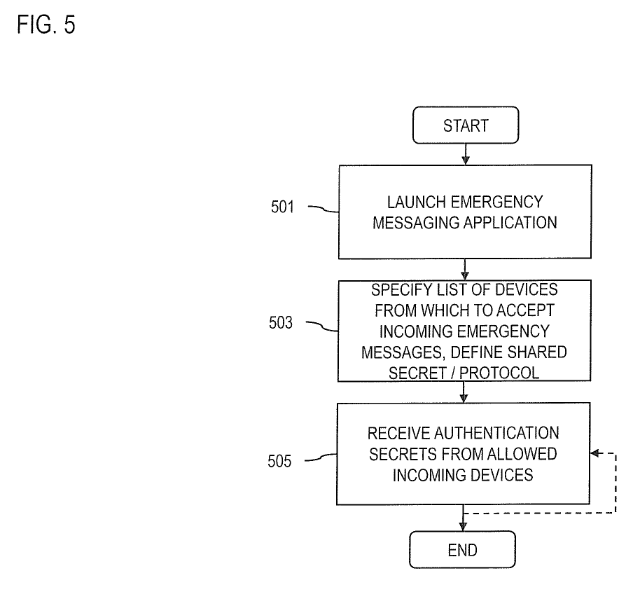

FIG. 5 is a flowchart of a process for configuring an emergency messaging application on a receiving device, according to an exemplary embodiment. In step 501, a user invokes the emergency messaging module 115 on the mobile device 103 from which the user intends to receive emergency messages. On the initial use, or in configuration mode after the initial use, for example, of the emergency messaging module 115, the user will be presented with a set of configuration options for a receiving device. It is contemplated that the user can subsequently be presented with an option by the module 115 to revise these configuration settings or preferences. During the configuration process, the user can specify from which devices the user will allow incoming emergency messages, and define a shared secret or protocol (step 503) (i.e., the user creates an “allowed devices list”). Specifying this list enables the emergency messaging module 105 to filter out unsolicited or unwanted messages that could potentially obscure legitimate emergency messages. This filtering also prevents denial of service attacks that can inundate the receiving device with a large volume of random messages and prevent legitimate messages from getting through. Once the configuration is completed, in listening mode, the emergency messaging module 115 is ready to receive authentication secrets from each allowed incoming device to validate potential incoming emergency messages (step 505). Step 505 may be repeated.

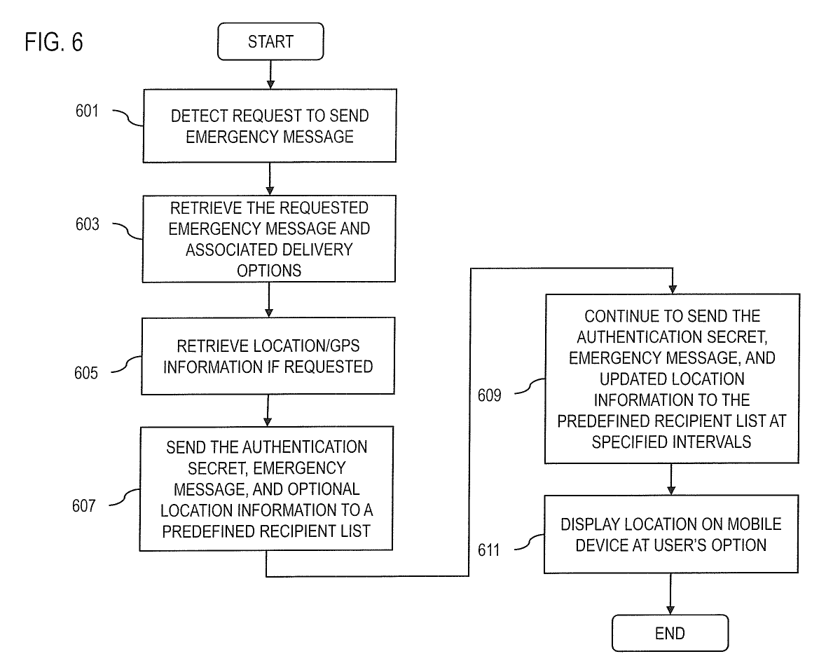

FIG. 6 is a flowchart of a process for sending an emergency message, according to an exemplary embodiment. In step 601, the emergency messaging module 115 (or platform 117) detects a user's request to send an emergency message by receiving a key or key sequence input from the user. During application setup, the user selects a key or key sequence that will trigger an emergency messaged as discussed above. A typical user likely will select a key or key sequence that can be quickly and discretely actuated during emergencies. Following entry of the user's pre-defined key sequence, the emergency messaging module 115 retrieves the emergency message and message delivery options associated with the key sequence (step 603). The message delivery options (as discussed above) include specifications on what format to send the emergency message, whether location information should be included, message recipients, etc. If the sender requests the inclusion of location information with the emergency message, the emergency messaging module 115 will retrieve the location infomation from the sending device's locator 301 (e.g., an on-board GPS receiver) (step 605).

In the next step 607, the emergency messaging module 115 creates the emergency message and sends it to the predefined recipient list associated with the message. In this embodiment, the emergency message contains the authentication secret, message content, and sending device location information. An exemplary text message format is: <authentication secret>: <message content>:Latitude:<value>:Longitude:<value> (e.g., “SECRET: SEND HELP:Latitude:37.4302488:Longitude:-122.10113545”). If the sender configured the emergency message to include periodic location updates, the emergency messaging module 115 continues to retrieve updated location information at specified time intervals (e.g., every 10 minutes) and sends location updates to the recipient list (step 609).

During setup, the user can configure whether the emergency messaging module 115 provides audio and/or visual feedback to indicate that an emergency message has been sent. If the user elects to receive feedback, the feedback could be any suitable audio alert (e.g., a beep or spoken message) or visual alert (e.g., confirmation message). This alert also can be a map display of the user's current location as in step 611.

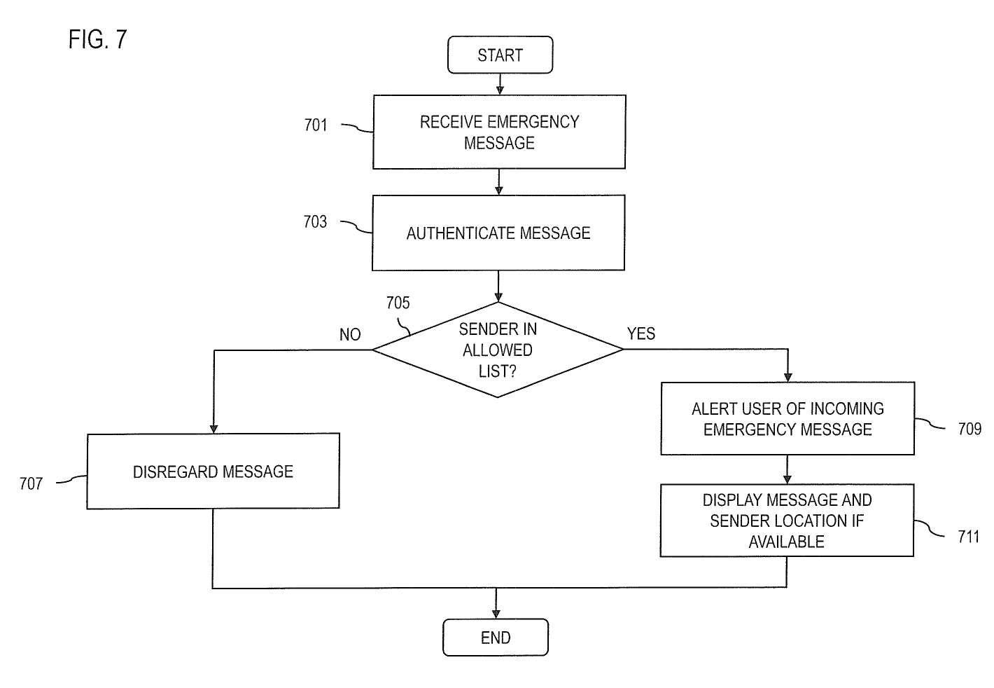

FIG. 7 is a flowchart of a process for receiving an emergency message, according to an exemplary embodiment. In step 701, a receiving device (e.g., device 103b) receives an emergency message from another device (e.g., device 103a). The emergency messaging module 115 within the receiving device authenticates the message to ensure that the message is valid per step 703. As discussed earlier, it is contemplated that any appropriate user-created authentication protocol can be used (e.g., biometric authentication). In this embodiment, the validation step involves the use of an authentication secret that has previously been shared between the sending and receiving devices. The receiving emergency messaging module 115 will parse the incoming emergency message to determine whether it contains the colTect authentication secret by comparing the received secret against the previously shared and stored secret. If the incoming emergency message is authenticated, the emergency messaging module 115 then determines whether the sending device is on its list of devices from which the receiving device will accept emergency messages (step 705).

Using an allowed devices list provides a second level of authentication by enabling the receiving device to filter out unwanted and unsolicited messages and prevent potential denial of service attacks that could obscure authentic emergency messages. In this embodiment, the emergency messaging module 115 will disregard emergency messages received from devices that are not on the allowed devices list (step 707). In other embodiments, the emergency messaging module 115 can be configured to notify the user of receiving device that an emergency message from a non-allowed device has been received or to store the message for later review. If the sending device is on the allowed devices list, the emergency messaging module 115 will notify the user (e.g., display a message, change color, play an audio alert, vibrate, etc.) of the incoming emergency message, identify the sender of the emergency message, display the emergency message, and display a map indicating any location or tracking information received with the emergency message (steps 709 and 711).

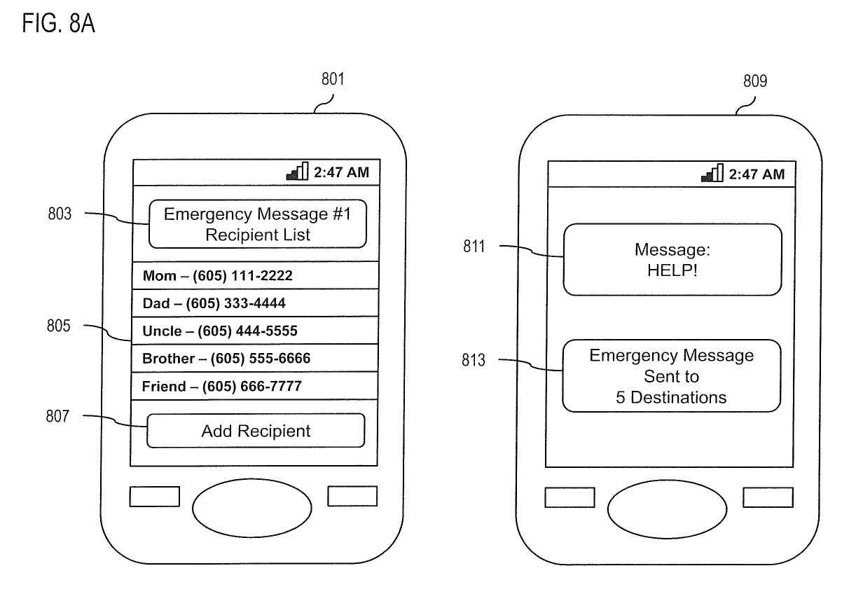

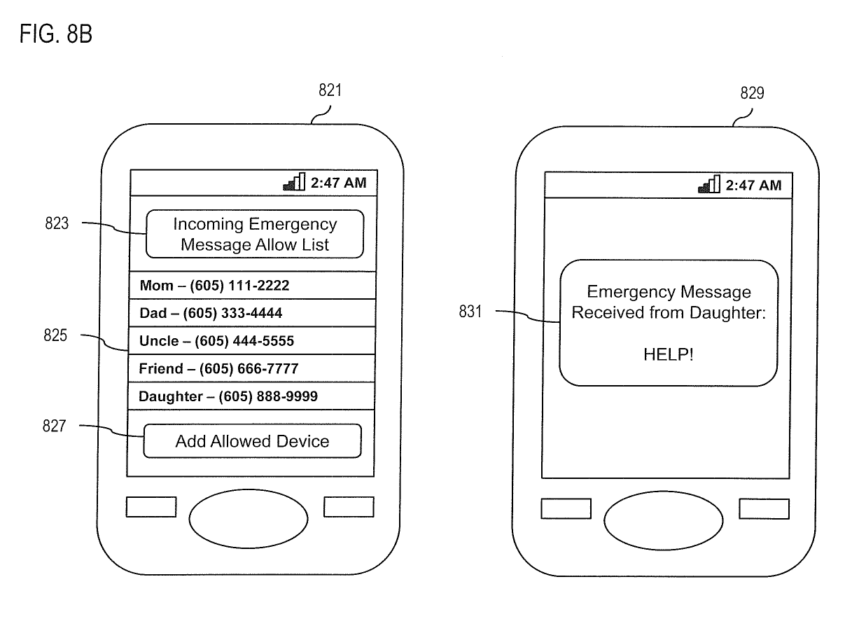

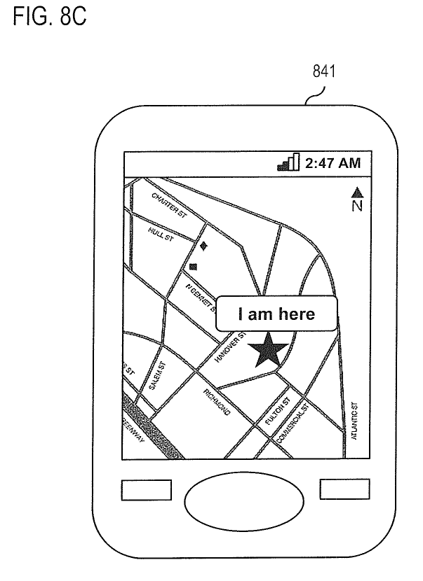

FIGS. 8A-8C are diagrams of exemplary controls and user interface screens of a mobile device utilized in the processes of FIGS. 4-7, according to an exemplary embodiment. FIG. 8A depicts exemplary user interface screens for a device used for sending emergency messages. User interface screen 801 is an exemplary user interface screen that enables creation of an emergency message recipient list. Screen 801 identifies the emergency message to which the recipient is applicable 803, displays the current recipient list 805, and provides a soft button for adding recipients 807. It is contemplated that the option to add additional recipients may be actuated by other means such as a hard button, key combination, etc. In this embodiment, the emergency messaging module 115 stores and displays a separate recipient list for each emergency message. This enables the user to organize and update each recipient list independently. FIG. 8A also depicts an optional user interface screen 809 to provide confirmation that the emergency messaging module 115 has sent the emergency message. In this embodiment, the user may configure whether to display confinnation screen 809. If the confirmation screen 809 is configured to be displayed, the screen 809 can include the content of the emergency message 811 and an indication of the number of devices to which the message was sent 813.

FIGS. 8B and 8C depict exemplary user interface screens for a device used for receiving emergency messages. User interface screen 821 of FIG. 8B is an exemplary user interface screen that enables creation a list of devices from which to receive incoming emergency messages 823. User interface screen 821 displays the current list of allowed devices 825 and provides a soft button for adding allowed devices 827. Similar to the interface screen above, it is contemplated that the option to add additional recipients may be actuated by other means such as a hard button, key combination, etc. User interface screen 829 of FIG. 8B is an exemplary emergency message display screen. On receipt of an authenticated emergency message, the emergency messaging module 115 displays an alert 831 which identifies the sender of the emergency message and displays the message content. In addition or alternately, the emergency messaging module 115 can use other means to alert the recipient such as changing colors of the screen, playing an audio alert, and/or vibrating. If the incoming emergency includes location information, the receiving device will display a map indicating the sender's location as depicted in user interface screen 841 of FIG. 8C.

As discussed earlier, it is contemplated that the emergency messaging module 115 operates without network intervention. However, there are certain embodiments of the invention in which a network-based emergency messaging platform 117 and host 119 (of FIG. 1) can be used to provide and access the functions and settings of the emergency messaging module 115.

The processes described herein for providing emergency messaging may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

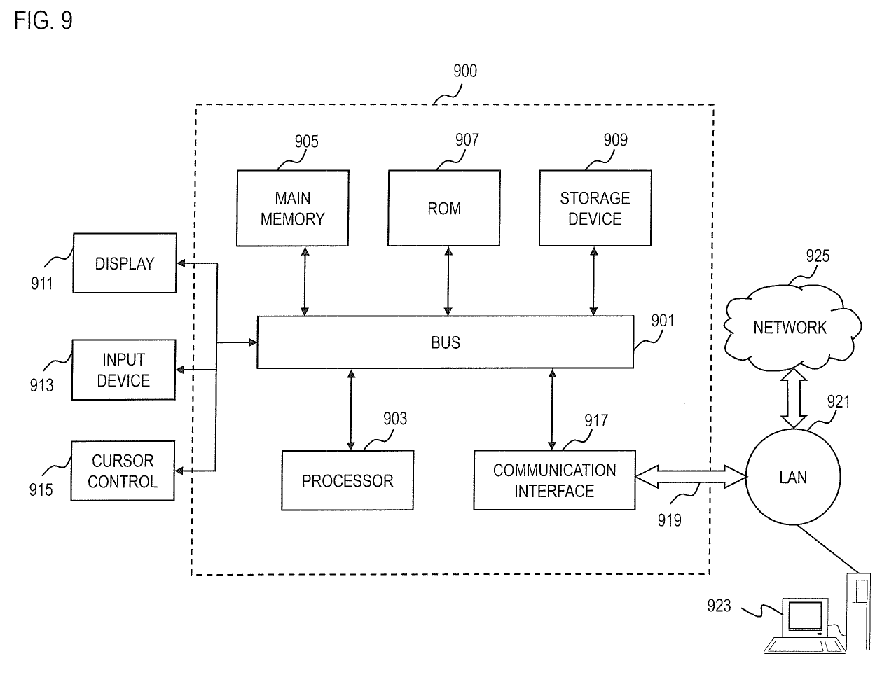

FIG. 9 illustrates computing hardware (e.g., computer system) upon which these embodiments can be implemented. The computer system 900 includes a bus 901 or other communication mechanism for communicating information and a processor 903 coupled to the bus 901 for processing information. The computer system 900 also includes main memory 905, such as random access memory (RAM) or other dynamic storage device, coupled to the bus 901 for storing information and instructions to be executed by the processor 903. Main memory 905 also can be used for storing temporary variables or other intermediate information during execution of instructions by the processor 903. The computer system 900 may further include a read only memory (ROM) 907 or other static storage device coupled to the bus 901 for storing static information and instructions for the processor 903. A storage device 909, such as a magnetic disk or optical disk, is coupled to the bus 901 for persistently storing information and instructions.

The computer system 900 may be coupled via the bus 901 to a display 911, such as a cathode ray tube (CRT), liquid crystal display, active matrix display, or plasma display, for displaying information to a computer user. An input device 913, such as a keyboard including alphanumeric and other keys, is coupled to the bus 901 for communicating information and command selections to the processor 903. Another type of user input device is a cursor control 915, such as a mouse, a trackball, or cursor direction keys, for communicating direction information and command selections to the processor 903 and for controlling cursor movement on the display 911.

According to an embodiment of the invention, the processes described herein are performed by the computer system 900, in response to the processor 903 executing an arrangement of instructions contained in main memory 905. Such instructions can be read into main memory 905 from another computer-readable medium, such as the storage device 909. Execution of the arrangement of instructions contained in main memory 905 causes the processor 903 to perform the process steps described herein. One or more processors in a multi-processing arrangement may also be employed to execute the instructions contained in main memory 905. In alternative embodiments, hard-wired circuitry may be used in place of or in combination with software instructions to implement the embodiment of the invention. Thus, embodiments of the invention are not limited to any specific combination of hardware circuitry and software.

The computer system 900 also includes a communication interface 917 coupled to bus 901. The communication interface 917 provides a two-way data communication coupling to a network link 919 connected to a local network 921. For example, the communication interface 917 may be a digital subscriber line (DSL) card or modem, an integrated services digital network (ISDN) card, a cable modem, a telephone modem, or any other communication interface to provide a data communication connection to a corresponding type of communication line. As another example, communication interface 917 may be a local area network (LAN) card (e.g. for Ethernet™ or an Asynchronous Transfer Model (ATM) network) to provide a data communication connection to a compatible LAN. Wireless links can also be implemented. In any such implementation, communication interface 917 sends and receives electrical, electromagnetic, or optical signals that carry digital data streams representing various types of information. Further, the communication interface 917 can include peripheral interface devices, such as a Universal Serial Bus (USB) interface, a PCMCIA (Personal Computer Memory Card International Association) interface, etc. Although a single communication interface 917 is depicted in FIG. 9, multiple communication interfaces can also be employed.

The network link 919 typically provides data communication through one or more networks to other data devices. For example, the network link 919 may provide a connection through local network 921 to a host computer 923, which has connectivity to a network 925 (e.g. a wide area network (WAN) or the global packet data communication network now commonly referred to as the “Internet”) or to data equipment operated by a service provider. The local network 921 and the network 925 both use electrical, electromagnetic, or optical signals to convey information and instructions. The signals through the various networks and the signals on the network link 919 and through the communication interface 917, which communicate digital data with the computer system 900, are exemplary forms of carrier waves bearing the information and instructions.

The computer system 900 can send messages and receive data, including program code, through the network(s), the network link 919, and the communication interface 917. In the Internet example, a server (not shown) might transmit requested code belonging to an application program for implementing an embodiment of the invention through the network 925, the local network 921 and the communication interface 917. The processor 903 may execute the transmitted code while being received and/or store the code in the storage device 909, or other non-volatile storage for later execution. In this manner, the computer system 900 may obtain application code in the form of a carrier wave.

The term “computer-readable medium” as used herein refers to any medium that participates in providing instructions to the processor 903 for execution. Such a medium may take many forms, including but not limited to non-volatile media, volatile media, and transmission media. Non-volatile media include, for example, optical or magnetic disks, such as the storage device 909. Volatile media include dynamic memory, such as main memory 905. Transmission media include coaxial cables, copper wire and fiber optics, including the wires that comprise the bus 901. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
receiving a text-based message from a mobile device;
determining whether the text-based message is an emergency communication;
receiving location information of the mobile device if the text-based message is determined to be an emergency communication.

2. A method of claim 1, further comprising:
authenticating the text-based message according to user-defined information contained within the text-based message.

3. A method of claim 1, wherein the user-defined authentication information is a pre-shared secret.

4. A method of claim 1, wherein the text-based message is either an electronic mail, an instant messaging (IM) message, a short message service (SMS) message, or a multimedia messaging service (MMS) message.

5. A method of claim 1, further comprising:
filtering the text-based message according to a predetermined list of allowed devices.

6. A method of claim 1, wherein the location information is included in the text-based message, and updated location information is periodically received.

7. An apparatus comprising:
an messaging module configured to receive a text-based message from a mobile device, and to determine whether the text-based message is an emergency communication,
wherein the messaging module is further configured to receive location information of the mobile device if the text-based message is determined to be an emergency communication.

8. An apparatus of claim 7, wherein the messaging module is further configured to authenticate the text-based message according to user-defined information contained within the text-based message.

9. An apparatus of claim 7, wherein the user-defined authentication information is a pre-shared secret.

10. An apparatus of claim 7, wherein the text-based message is either an electronic mail, an instant messaging (IM) message, a short message service (SMS) message, or a multimedia messaging service (MMS) message.

11. An apparatus of claim 7, wherein the messaging module is further configured to filter the text-based message according to a predetermined list of allowed devices.

12. An apparatus of claim 7, wherein the location information is included in the text-based message, and updated location information is periodically received.

13. A method comprising:
retrieving authentication information associated with a recipient, wherein the authentication information is designated for an emergency communication;
obtaining location information;
generating a text-based message including an emergency message, the authentication information, and the location information; and
transmitting the text-based message to the recipient.

14. A method of claim 13, wherein the authentication information is user-defined.

15. A method of claim 13, wherein the text-based message is either an electronic mail, an instant messaging (IM) message, a short message service (SMS) message, or a multimedia messaging service (MMS) message.

16. A method of claim 13, further comprising:
updating the location information; and
transmitting the updated location information to the recipient.

17. A method of claim 13, further comprising:
invoking an emergency messaging application by either an assigned key, a predetermined key sequence, a physical button, a soft button, or a combination thereof.

18. A method of claim 13, further comprising:
storing a plurality of pre-defined emergency messages including the emergency message.

19. A mobile apparatus comprising:
an emergency messaging module configured to retrieve authentication information associated with a recipient, wherein the authentication information is designated for an emergency communication;
a locator configured to obtain location information of the mobile apparatus, wherein the emergency messaging module is further configured to generate a text-based message including an emergency message, the authentication information, and the location information; and
a transceiver configured to transmit the text-based message to the recipient.

20. A mobile apparatus of claim 19, wherein the authentication information is user-defined.

21. A mobile apparatus of claim 19, wherein the text-based message is either an electronic mail, an instant messaging (IM) message, a short message service (SMS) message, or a multimedia messaging service (MMS) message.

22. A mobile apparatus of claim 19, wherein the location information is updated and transmitted to the recipient.

23. A mobile apparatus of claim 19, further comprising:
an input device configured to invoke the emergency messaging module by either an assigned key, a predetermined key sequence, a physical button, a soft button, or a combination thereof.

24. A mobile apparatus of claim 19, further comprising:
a memory configured to store a plurality of pre-defined emergency messages including the emergency message.
